(19) United States
(12) Patent Application Publication
(10) Pub. No.: US 2004/0100396 A1
(43) Pub. Date: May 27, 2004

(54) Remote synchronisation

(76) Inventors: Chris Antico, New South Wales (AU); Leslie Green, New South Wales (AU)

Correspondence Address: NATH & ASSOCIATES, 1030 15th STREET, 6TH FLOOR, WASHINGTON, DC, 20005, US

(21) Appl. No.: 10/257,833

(22) PCT Filed: Apr. 19, 2001
(86) PCT No.: PCT/AU01/00449

(30) Foreign Application Priority Data
Apr. 20, 2000 (AU) PQ 7053
Oct. 13, 2000 (AU) PR 0749

(51) Int. Cl. G08G 3/00

(52) U.S. Cl. 340/985

(57) ABSTRACT

A synchronisation system for synchronisation of multiple markers (12,13,14) in a geographical location or waterway (16). Synchronisation is achieved by periodically re-synchronising each marker (12,13,14) to a common reference signal. A wireless communications system is used to distribute the reference signal to isolated markers. The markers (12,13,14) are also remotely monitored to indicate the status of multiple markers which is communicated to a central control centre. The status can indicate the number of spare light bulbs left. the status of the spare bulbs, the correct or incorrect flashing of the light, unauthorised entry to or tampering with the marker or lighthouse. the condition of the battery and/or the correct function of a solar panel or other remote power source. The status of multiple markers is then communicated to a central control centre or to another location.

### INTRODUCTION

The present invention relates generally to the use of telemetry for remote monitoring and control, and in particular, the invention provides an improved system for monitoring and synchronisation of multiple remote devices to a reference time

### BACKGROUND OF THE INVENTION

Channel markers, buoys or lighthouses (referred to herein as “markers”) are used to indicate safe shipping channels for marine navigation. To assist navigators with nighttime navigation, these markers flash at regular intervals. However, at night it is often difficult to judge relative distances, particularly when negotiating in moonless conditions in which a marker and its surroundings may be essentially invisible and only the flashing light is visible to the navigator. Under such adverse conditions, it may be almost impossible to determine which of a number of markers is closer, making navigation difficult and hazardous.

Often, where a navigable channel is relatively narrow, markers are located in pairs, marking the left and right banks of a river, channel or waterway. Vessels generally try to navigate between pairs of markers as they travel up and down the river, channel or waterway. However, where the navigable channel changes direction, such as in the case of a bend in a river, if the navigator mistakenly chooses the wrong pair of markers to use on a particular section of the channel, due to the problem of judging distance at night and heads between them, he may run aground on the river bank or collide with some other hazard.

By arranging groups of markers, such as pairs of opposed markers, to flash in a synchronised pattern, it is easier for the skipper to select which group of markers to navigate between. By arranging markers and groups of markers so that they successively flash along a river or waterway, the skipper gets a better indication of the direction to navigate. For example, the first marker or pair of opposed markers at the head of a river could flash, followed by the next marker or pair of markers up the river, and the next and so on up the river. In the case of a bay, the lights could be synchronised to flash one after another around the circumference or perimeter of the bay.

Markers can be fitted with a light bulb changer which allows the marker to go unserviced for longer periods, however even so, markers need reasonably regular inspection and maintenance in order to ensure reliable service. The changer will automatically change to a new bulb when one fails and will typically rotate in the order of six bulbs into service before requiring maintenance. When all spare blubs have failed, the marker ceases to flash. A marker not flashing can present a danger to shipping, and as the length of time a light bulb lasts varies considerably, the marker must still be checked reasonably regularly to reduce the risk of the marker failing. The cost of manual marker maintenance can be very high, especially as markers are often located at isolated locations. Markers can also be inaccessible during times of bad weather, when they are needed most. A remote monitoring capability that allows the number of spare bulbs to be determined can reduce this cost of maintenance.

### SUMMARY OF THE INVENTION

According to a first aspect, the present invention consists in a system of navigational aids comprising a plurality of navigation lights, each light being connected to a flashing circuit such that the light flashes with a predetermined frequency, the system further including synchronisation means to synchronises the flashing circuit with a predetermined time base.

According to a second aspect, the present invention consists in a telemetry system for communicating with a plurality of navigation lights, each navigation light being connected to a flashing circuit having timing means to provide a time base, and the flashing circuit being arranged to use the time base to flash the light at predetermined intervals, and each flashing circuit being responsive to the telemetry system to synchronise the respective flashing to a synchronising signal transmitted by the telemetry system, such that the flashing of the plurality of lights can be synchronised to one another by the telemetry system.

In a preferred embodiment, the telemetry system is also capable of collecting information from the light, such as the condition of batteries, the expected remaining bulb life or, in the case of a light with a bulb changer, the number of bulbs left.

By installing a synchronisation system in association with a system of markers located in or around a given waterway, the markers can be made to flash at the same time or in a desired sequence.

Embodiments of the invention include communication means to enable the markers to be synchronised. Methods of synchronisation could include transmitting a broadcast signal to multiple markers in a waterway to set a reference clock or signal within each marker unit. This reference signal could be periodically re-sent to ensure that the marker internal reference clock is within acceptable limits. The synchronisation could similarly come from a device such as the reference clock of the GPS system.

Alternatively the internal time reference signal of multiple markers could be set one by one against a centrally maintained reference signal or from a continuous reference broadcast signal which is sampled and set as a result of a point to point communication.

Yet another method is to allow one light to transmit a reference to another marker, or, for a marker to detect the flash of a light source or another marker and then set a reference signal.

In addition, the invention includes a monitoring function, which is capable of monitoring the status of a marker and communicating the status of the marker to a remote site. This communication maybe either via a wired or wireless connection. This information would typically be communicated back to a central monitoring and control centre.

Monitoring could include an indication of the number of spare light blubs left or the status of these bulbs, a light detector arranged to monitor whether the light is flashing correctly, a tamper indicator to detect unauthorised entry to the marker or lighthouse, the condition of the battery or the correct function of a solar panel or other remote power sources.

### BRIEF DESCRIPTION OF THE DRAWING

An embodiment of the invention will now be described by way of example, with reference to the accompanying drawings, in which:

FIG. 1, is a diagram illustrating a typical arrangement of markers in a river, channel or waterway;

FIG. 2 is a systems diagram for a first embodiment of the invention;

FIG. 3 illustrates the synchronisation of multiple markers using a GPS network;

FIG. 4 shows a marker communicating with several GPS satellites to calculate position and a common time reference for synchronisation;

FIG. 5 is a system block diagram of marker electronics, for the embodiment of FIGS. 2 to 4;

FIG. 6 shows a synchronisation functional diagram in respect of the embodiment of FIGS. 2 to 5;

FIG. 7 is a block schematic circuit diagram of a Beacon Control Module of the embodiment of FIGS. 2 to 6;

FIG. 8 is a diagram of a GSM communications module used in the circuit of FIG. 7;

FIG. 9 is a diagram of the physical arrangement of a globe changer used in a navigation light intended to be fitted with the Beacon Control Module of FIG. 7;

FIG. 10 is an electrical schematic diagram of the globe changer of FIG. 9; and

FIG. 11 is a block diagram illustrating a typical configuration for a GSM installation according to a second embodiment of the invention.

### DETAILED DESCRIPTION OF THE PREFERRED EMBODIMENTS

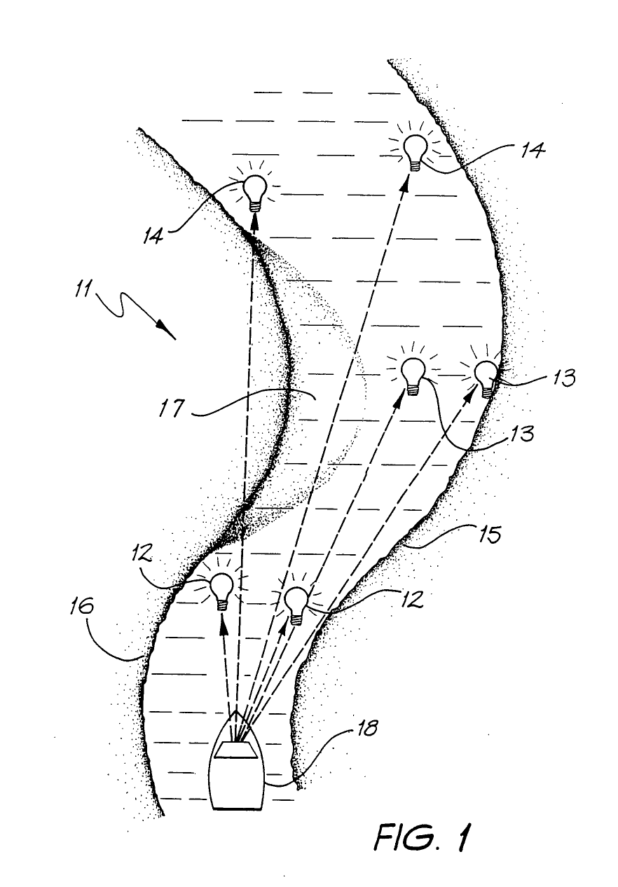

Referring to FIG. 1 a typical waterway is illustrated, having two riverbanks 15, 16, a concealed sandbank 17 and pairs of markers 12, 13, 14 along the channel. To safely navigate the channel, it is necessary for a vessel 18 to navigate between adjacent pairs of markers. Therefore, by arranging each pair of markers 12, 13, 14 to flash together and introducing a delay between pairs of markers, the system can cause marker pair 12 to flash first, then pair 13 and then pair 14. This helps the navigator to determine which are the pairs of markers and the order they should be passed.

The preferred embodiments of the invention provide a communications method to enable remote synchronisation of markers, as well as monitoring and control circuitry capable of detecting a number of undesirable conditions in a marker.

In simple embodiments, an ability to synchronise or sequence multiple markers in a geographical location or waterway is provided. In order to achieve this each marker must be able to be synchronised to a reference signal. Markers may contain an internal reference signal that is periodically re-synchronised to a master reference or markers may receive a signal for each flash sequence. A wireless communications system such as a GSM or CDMA telephone link or similar would be used to receive this signal.

In other embodiments of the invention, remote monitoring of the marker status is provided. The information reported by the monitoring system may include the number of spare light blubs left or the status of these bulbs, a light detector arranged to monitor whether the light is flashing correctly, a tamper indicator to detect unauthorised entry to the marker or lighthouse, the condition of the battery and/or the correct function of a solar panel or other remote power source.

The marker status will be communicated to a central control centre or to another location, either at the same time that synchronisation occurs or independently of the synchronisation operation. The communication system allows multiple markers to be monitored and would permit activities such as maintenance work to be scheduled based on the status of the battery or number of spare globes left in the marker. An alarm would also be raised when an unauthorised person tampers with the marker, or the marker is affected by the attention of wildlife such as birds or seals etc.

Both the monitoring and synchronisation functions of embodiments of the invention can be combined to provide a more comprehensive marker monitoring and control capability. In some embodiments, the method of communication for the synchronisation may be different from that of the monitoring system. For example, synchronisation may typically be performed by systematically polling or contacting each unit in the system, whereas, alarm conditions such as unexpected failure or tampering would require a call to base mode of operation. Different communications channels and techniques might also be employed.

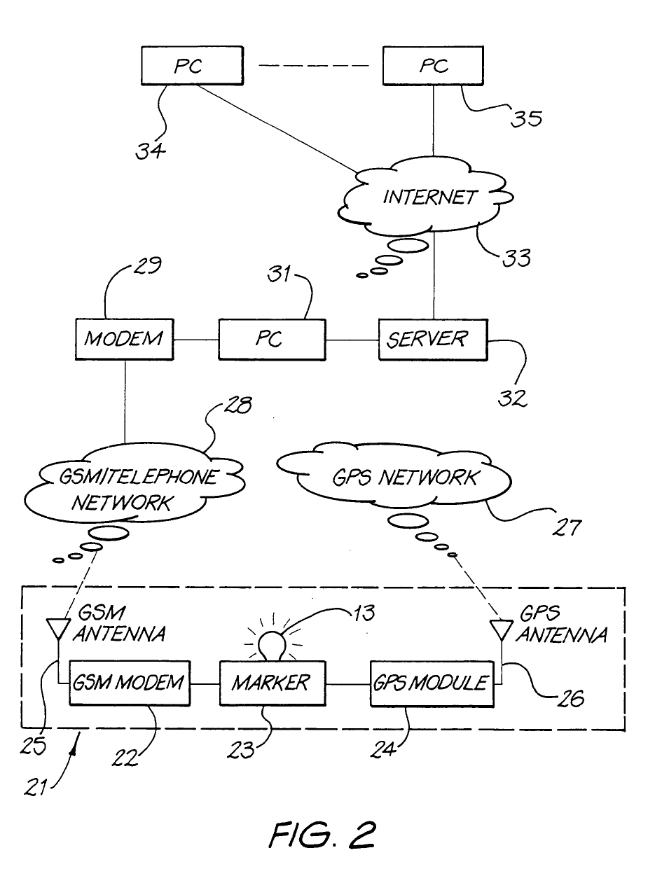

Referring to FIGS. 2 to 6 a first embodiment of the invention comprises a communications method, and monitoring and control circuitry capable of detecting a number of conditions in a marker.

In one variation of this embodiment, the system simply provides the ability to synchronise or sequence multiple markers in a geographical location or waterway. In order to achieve this each marker must be able to be synchronised to a reference signal. Markers may contain an internal reference signal that is periodically re-synchronised to a master reference or markers may receive a signal for each flash sequence. A communications method would be used to receive this signal.

In another more advanced version of the illustrated embodiment, remote monitoring of the marker status is also provided. The monitored functions can include any one or more of

a) the number of spare light blubs left;

b) the status of the spare bulbs;

c) a light detector arranged to monitor correct flashing of the light;

d) a tamper indicator to detect unauthorised entry to the marker or lighthouse;

e) the condition of the battery and/or the correct function of a solar panel or other remote power source.

The marker status can then be communicated to a central control centre or to another location. The invention would then allow multiple markers to be monitored. This would allow, for instance, maintenance work to be scheduled based on the status of the battery or number of spare globes left in the marker, or the raising of an alarm when the marker is tampered with by an unauthorised person or bird or seal etc.

Both the monitoring and synchronisation aspects of the invention can be combined to provide a more comprehensive marker monitoring and control capability. In the case of the combined embodiment, the method of communication for the synchronisation system may be different from that of the monitoring system.

An example of overall systems diagram is shown in FIG. 2. It shows a navigational marker assembly 21, containing a GSM modem 22 which could be substituted for another kind of communications device such as CDMA, UHF or Satellite link. The navigational marker assembly 21 also includes a marker unit 23 that contains the marker electronics, mechanical changer and light assembly and a GPS module 24. The GSM Module 22 communicates to the web server 32 via a PC 31 and a modem 29 using the GSM and telephone networks 28. The data gathered by the PC 31 is then put on a web server 32 and made available over the web/Internet 33 to end users for viewing via a web browser on a PC 34, 35.

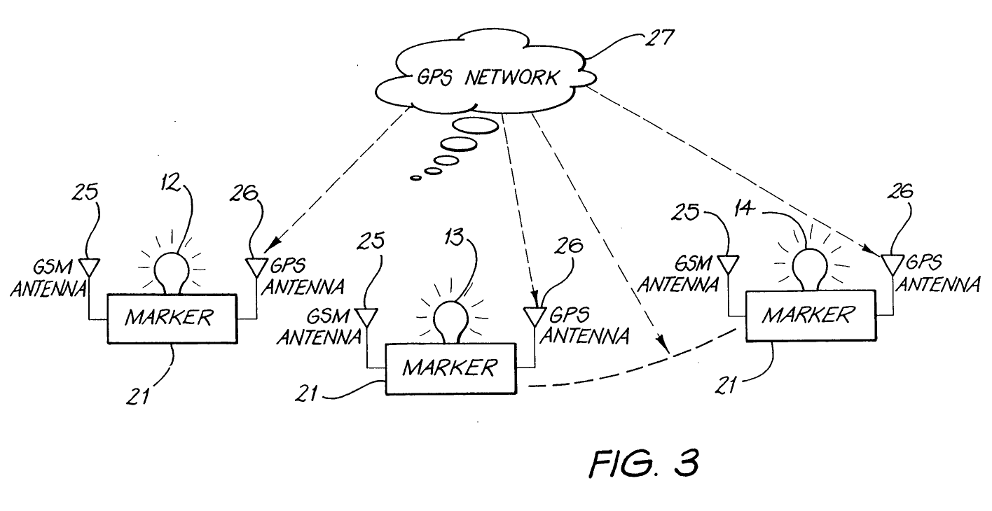

FIG. 3 shows the synchronisation of multiple markers 12, 13, 14 using the GPS network 27. The GPS network broadcast timing information which is decoded in the marker 12, 13, 14 to generate timing information in order to synchronise markers globally and to gain positioning information.

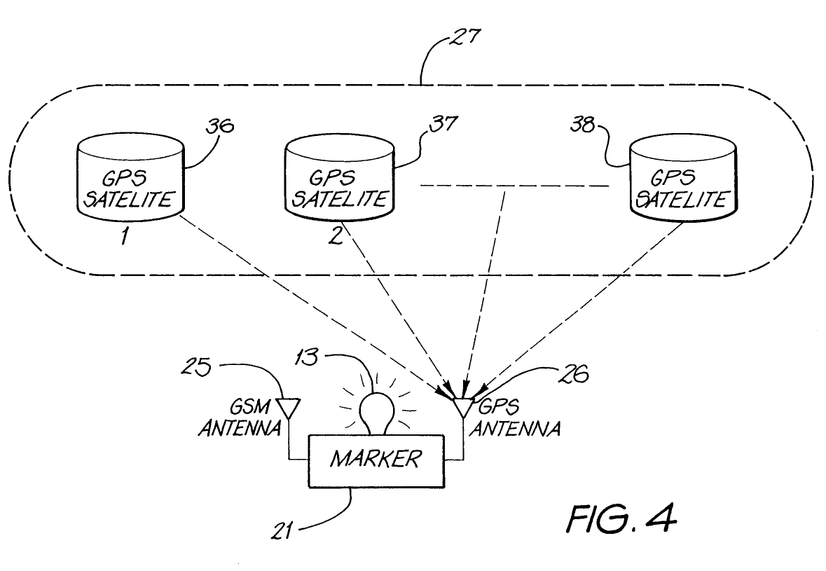

FIG. 4 shows the marker 13 communicating with several GPS satellites 36, 37, 38 to calculate position and a common time reference for synchronisation. Generally the marker will communicate with at least 4 satellites.

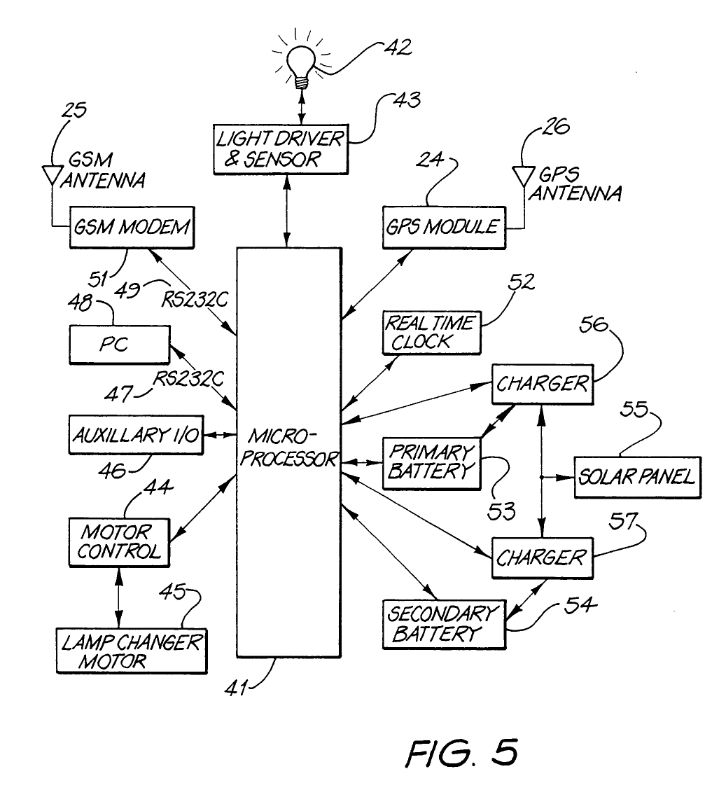

FIG. 5 is a system block diagram of marker electronics. It shows a microprocessor 41, capable of communicating with an array of peripheral devices and having a firmware program capable of controlling these various peripheral devices and gathering data from the devices, in order to carry out the correct function of the marker. The microprocessor contains memory to store the firmware program and to store data such as events. The marker is capable of storing information on events such as the time the light was turned on and off, the solar panel voltage and current, the battery voltage and current, the GPS position the GSM signal strength, passwords for access control, etc. The marker contains a motorised lamp changer 42 holding 6 lamps one of which is connected to the light driver 43 at any one time. The lamp changer 41 can cause a new globe to be selected when instructed to do so by the microprocessor via the motor control 44 that controls the changer motor 45. The marker also contains auxiliary input/output signals 46 that can be configured for other devices such as tamper switches, etc. The marker contains 2 serial interfaces one interface 47 for connection to a local PC 48 for local configuration of the marker, down loading of logged events etc, and a second interface 49 connected to a GSM modem 51 or CDMA modem or InMarsat modem or UHF modem or other kind communication device. This then allows connection and data transfer between the host system 31 (see FIG. 2) and the marker. A real-time clock 52 is provided to maintain an accurate time reference. To save battery power, the GPS unit is only activated every 30 minutes to resynchronise the real-time clock 52. Main and secondary batteries used to power the marker. The secondary battery 53, 54 are used to allow the electronics and communications to continue to operate after the main battery 53, which powers the lamp 42 and motor drive 45 is flat. The marker is capable of initiating a call to the host 31 when an event such as a lamp failure occurs, or receiving a call when the marker status is required by remote monitoring systems. The solar panel 55 is capable of charging the primary and secondary batteries 5 3, 54 via the charger circuits 56, 57.

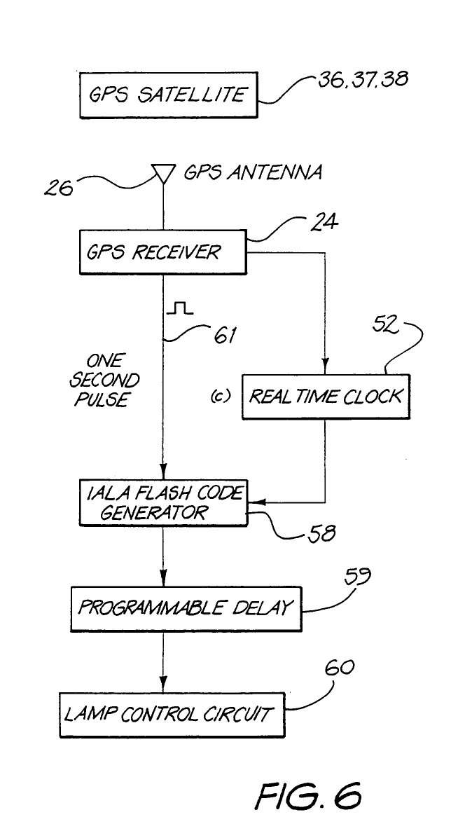

FIG. 6 shows the synchronisation functional diagram. The GPS receiver module 24 receives signals from several GPS satellites 36, 37, 38 (see FIG. 3) and calculates the time. This time is then used to update the Real-Time Clock 52. The GPS module 24 also produces a one-second timing pulse 61, accurate to within several milliseconds. The Real-Time Clock 52 is then used determine the start of a flash sequence to within a few tens of milliseconds and the one second pulse is then used to accurately start the sequence to within a few milliseconds. The Real-Time Clock “RTC” 52 is referenced to midnight on the 1 Jan. 1980. The flask code generator 58 is capable of generating IALA flash sequences or a flash sequence programmed in by an operator. The flash sequence then determines how many flash sequences since midnight on the 1 Jan. 1980 in order to calculate when to start the next sequence. A programmable delay 59 can also be introduced to delay the start of each flash sequence. The output of the delay is then connected to the lamp via the lamp control circuit 60. The GSM module 5 7 and local PC connection 47 allows changes to be made to the IALA code or the flash delay.

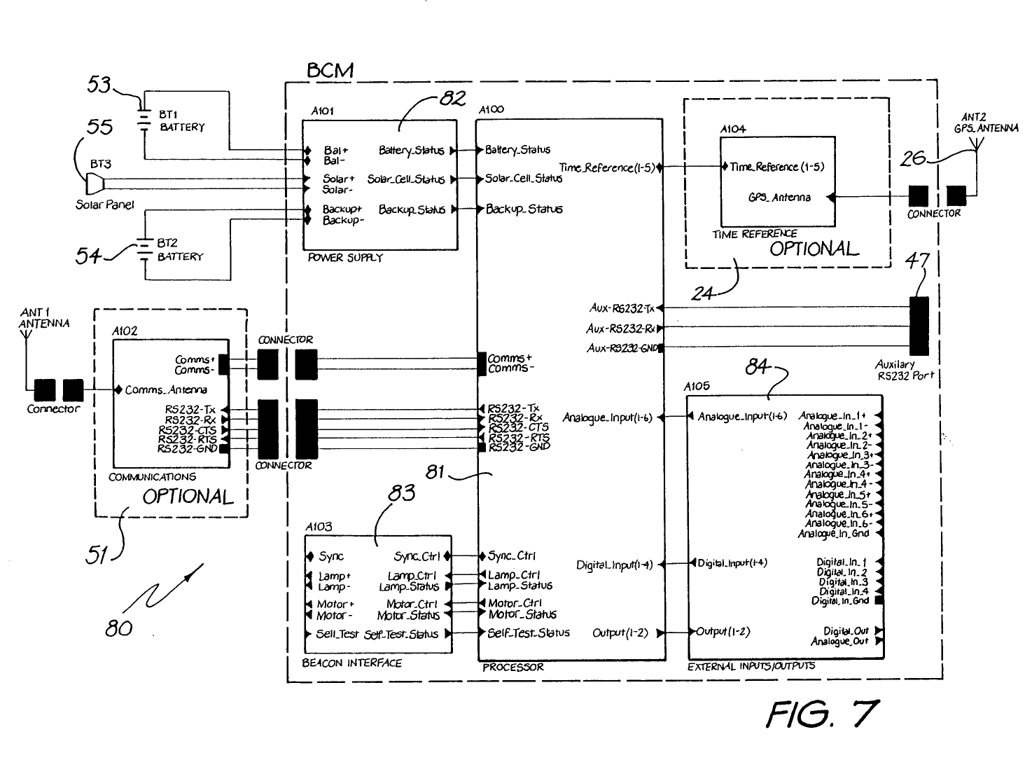

Referring to FIG. 7, a block schematic of a Beacon Control Module (BCM) 80 is illustrated. The BCM is made up of a number of modules some of which are optional and their inclusion or omission depends on overall system specifications. The modules of the BCM 80 are:

i) A Processor 81 which is programmed to control and operate the Beacon synchronisation and monitoring components.

ii) A Power Supply 82 which conditions power from a solar panel 55 and also incorporates the battery chargers 56 and 57 which charge the Primary Battery 53 and Secondary Battery 54 respectively.

iii) A Communications Module 51 (optional) which provides two way wireless communication over a GSM phone network. The communications module 51 is used to transmit buoy status to the central monitoring facility when monitoring functions are implemented. It may also be used to receive synchronisation data when other optional independent synchronisation techniques are not employed.

iv) A Beacon Interface 83 which provides the motor control function 44 for the lamp changer and other lamp control and monitoring functions.

v) A Time Reference 24 (optional) comprising a GPS receiver for receiving a GPS generated time reference signal when required by the system specification. This time reference input is optionally used instead of a time reference derived via the communications module, either when monitoring is not required or when time reference via the communications module is otherwise not desirable.

vi) An Auxiliary RS232C Communications Port 47 provided to allow future expansion or for direct communication with the processor during maintenance.

vii) Auxiliary (External) Inputs/Outputs 84 also provided for future expansion, and include a variety of analogue and digital inputs and outputs providing versatile interfaces allowing future connections of as yet unspecified extensions to the system.

The power supply module 82 to performs the tasks of:

Supply and regulation of power to all system modules within a BCM (including the optional Communications and Time Reference modules).

Monitoring beacon battery voltage. p1 Monitoring BCM backup battery voltage.

Regulation of the battery charging from the solar panel(s).

Monitoring solar panel voltage.

Monitoring solar panel charge current.

Protecting the solar panel(s) from reverse current flow when battery voltage is higher than the solar panel(s) output voltage. This will also protect against night losses.

Allow for solar panel Open circuit (O/C) and short Circuit (S/C) testing.

The communications module 57 performs the tasks of:

Alerting a Base Station/central control centre that an alarm condition has been detected by the BCM.

Allowing a Base Station/central control centre to remotely obtain the status of a BCM.

Allowing a Base Station/central control centre to remotely configure a BCM.

Allowing a Base Station/central control centre to update the time of a BCM's real-time clock.

Uploading data logs to a Base Station/central control centre.

The beacon interface module 83 performs the tasks of:

Illuminating/extinguishing lamps.

Sensing for lamp failures.

Driving the lamp changer motor.

Generating/accepting sync pulses.

Monitoring the Self Test button.

Signal Definitions within the Beacon Interface Module

| Description | Min | Typical | Max | Units | Notes |
|---|---|---|---|---|---|
| Lamp Supply Voltage | 12.0 | 12.0 | 13 | V | Lamp+ to Lamp− |
| Lamp Supply Current | 0.25 | 0.55 | 5.0 | A | |
| Motor Drive Voltage | 0.0 | | 5.0 | V | Motor+ to Motor− |
| Motor Drive Current | | 110-135 * | 800 | mA | Duty Cycled |
| Motor Rotation Rate | | 6 | | RPM | |
| Sync Terminal Input Voltage | 0.0 | | 5.0 | V | |
| Sync Pulse High Threshold | 3.5 | | | V | May vary |
| Sync Pulse Low Threshold | | | 0.6 | V | May vary |
| Sync Terminal Input | | 10.0 | | kΩ | |
| Impedance | | | | | |
| Self Test Input Voltage | 0.0 | | 5.0 | V | |
| Self Test High Threshold | 3.5 | | | V | May vary |
| Self Test Low Threshold | | | 0.6 | V | May vary |
| Self Test Input Impedance | | 10.0 | | kΩ | |

* this value was determined by measurements made on one sample STA lamp changer, and as such should not be considered as truly typical.

The time reference module 24 allows synchronisation of the BCM's real-time clock with the UTC time reference found on GPS transmissions.

The only external connection to the Time Reference module is the GPS antenna connection. This connection will be via a weatherproof panel mount coaxial connector. This connector is physically different to that used for the Communications module antenna, to reduce the risk of connecting an antenna to the wrong module.

The auxiliary RS232 port 47 allows connection of a laptop computer or other RS232 equipped device, for the purpose of (re)configuring and maintaining a BCM. The auxiliary RS232 port uses a 3-wire interface as hardware handshaking is not be required for this type of functionality.

The external input terminals of the auxiliary input/output module 84 are present so that a BCM can be connected to a number of signal sources not directly related to a 6 lamp changer unit. These signals can then be monitored and logged by the BCM. For units configured with a communications module there will exist the option to configure the BCM to alert the Base Station/central control centre that an alarm condition has been detected for one of the external inputs.

The external output terminals are present so that a BCM can trigger external equipment/devices in the event of the BCM detecting an alarm condition, or at the request of a Base Station/central control centre. The external outputs must be constant voltage steady state signals. As the variety of possible external signals is infinite, it is unrealistic to design an input port capable of handling every conceivable signal. As such, the I/O ports of a BCM will be limited to specific input and output signal types and levels. For signals that do not comply to the inputs accepted by a BCM, it will be necessary to convert these signals (via use of a third party circuit) into compliant signals before they are applied to the BCM's external input terminals.

Signal Definitions for the Auxiliary Input/Output Module

| Description | Min | Typical | Max | Units | Notes |
|---|---|---|---|---|---|
| Analogue Inputs #1-4 ⁺⁺⁺ | 0.0 | 5.0 | 10.0 | V | Differential Input, |
| | | | | | 100 Hz sampling rate |
| Analogue Inputs #5-6 ⁺⁺⁺ | 4.0 | | 20.0 | mA | Differential Input, |
| | | | | | 100 Hz sampling rate |
| Analogue Input GND | | 0.0 | | V | Common ground for |
| | | | | | all analogue inputs |
| Digital Inputs #1-4 | 0.0 | | 5.0 | V | 100 Hz sampling rate |
| Digital Input GND | | 0.0 | | V | Common ground for |
| | | | | | all digital inputs |
| Analogue Output Voltage ⁺⁺⁺ | 0.0 | | 12.0 | V | 100 Hz update rate |
| Analogue Output Current ⁺⁺⁺ | | | 20.0 | mA | |
| Digital Output Voltage | 0.0 | | 5.0 | V | 100 Hz update rate |
| Digital Output Current | | 20.0 | mA | | |

⁺⁺⁺ Analogue I/O signals will connect to a pair of input terminals for each signal (i.e. there will be 12 input terminals for the 6 input signals)

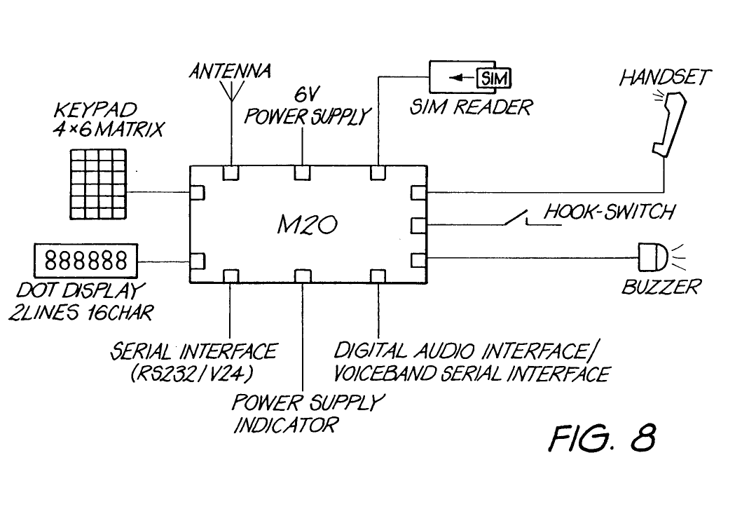

The optional communications module 51 is preferably an off the shelf device manufactured by Siemens™ and designated an M20. This device, which is schematically illustrated in FIG. 8, is designed both for handling complex industrial applications such as telemetry, telematics or communication, and for integration in stationary or mobile applications anywhere in the world where there is a compatible GSM, and combines the following features:

1) Adheres to “normal mobile station” requirements (−104 dBm sensitivity) rather than “small mobile station” requirements (−102 dBm sensitivity);

2) Voice transmission with Enhanced Full Rate EFR and Full Rate FR

3) Data transmission rate up to 9600 bit/s transparent and nontransparent;

4) Group 3 fax service

5) SMS (text mode, PDU, MT, MO) and SMS Cell Broadcast;

6) Integrated echo suppression and noise reduction for handset;

7) Digital audio interface;

8) SIM Lock;

9) Network and service provider personalization according to GSM 02.22;

10) Reloadable software;

11) GSM900 phase II;

12) Compatible in terms of function and control with the GSM modules M1 and A1;

13) 2W power part (class 4);

14) Single input voltage (6.0 V);

15) Average current: speech mode 200 mA/idle mode 20 mA;

16) Dimensions L×W×H in mm: 86.8×41.4×11.2;

17) Weight: 38 g;

18) Temperature range: −20° C. to +55° C.;

The interfaces available on the Siemens M20 device include:

1) One serial interface (control, data transmission and software updates) (Used by BCM)

2) SIN card reader interface for 3 V SIM cards. (used by BCM)

3) Analog interface for headset and microphone connection (telephone receiver) (Not presently used by BCM)

4) Digital Audio Interface (DAI) ) (Not presently used by BCM)

5) Echo suppression for handsfree mode can be implemented by an external connection (Not presently used by BCM)

6) Ringer interface (Not presently used by BCM)

7) Different ring volumes can be set (Not presently used by BCM)

8) Input port (Not presently used by BCM)

9) The power supply status of the application can be signalled on the display (network operation, battery operation, battery supply jeopardised, no display) (Not presently used by BCM)

10) Display interface (Not presently used by BCM)

11) Display controller for dot display can be controlled (2 lines×13 characters). (Not presently used by BCM)

12) Antenna connection (Used by BCM)

13) Interface for a keypad with 4×6 keyboard matrix. (Not presently used by BCM)

14) Interface to a tuning fork contact (hookswitch) (Not presently used by BCM)

15) Power supply (Used by BCM)

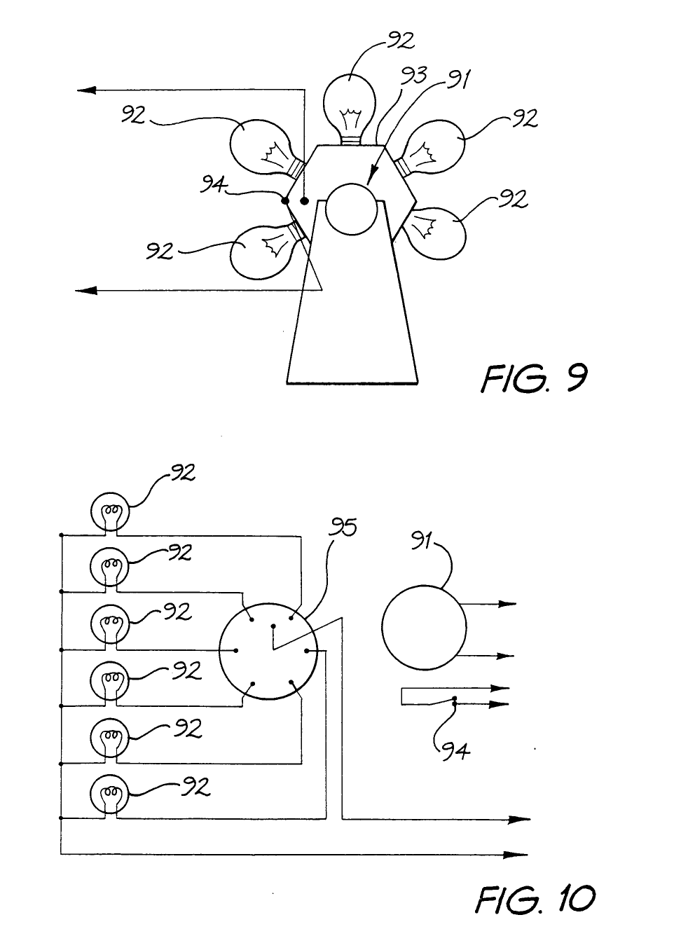

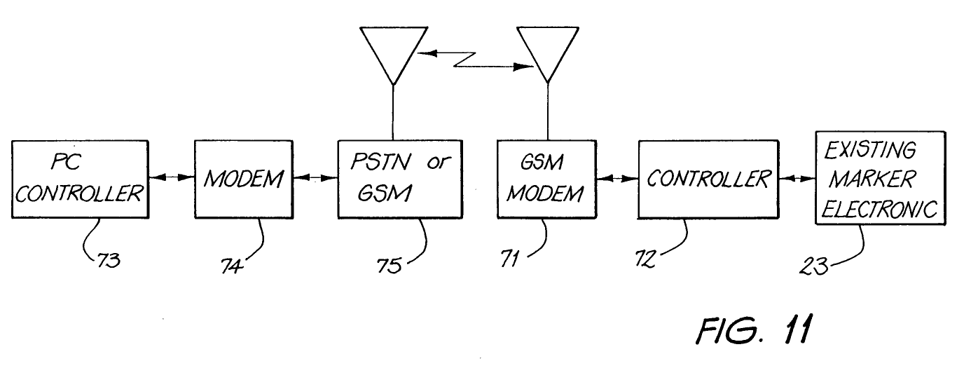

Turning to FIG. 9 one type of globe changer used in some navigation marker buoys is schematically illustrated. The globe changer comprises a motor 91 to drive the lamp changer, a plurality of globes 92 (typically 6) mounted on a carousel changer 93, and a micro-switch 94 to indicate each changing of a globe enabling counting of the number of globes that have been used. FIG. 10 illustrates the electrical schematic for the globe changer of FIG. 9. In this schematic, the globes 92 are connected to a rotary switch 95 which connects the currently selected globe to the beacon interface 51 of the BCM 80. The motor 91 and a lamp-locating switch 94 are also illustrated and are also connected to the beacon interface 51 of the BCM 80. The lamp-locating switch is used to indicate correct positioning of a currently selected globe for use.

Another embodiment of the invention is illustrated in FIG. 11 in which a GSM modem 71 and control board 72 are located in each marker. A central control centre 73 calls each marker once a day using a modem 74 and the PSTN/GSM network 75 to check on the number of spare bulbs remaining and the status of other parts of the marker such as the battery. It then performs a re-synchronisation procedure which involves requesting the marker to send a data packet to the control centre. The transmission of the data packet is triggered by the marker's reference clock. The central control centre then compares the data to the master reference. If the signal is outside acceptable timing tolerance the central control centre sends a packet corresponding to the master reference signal and requests the marker to re-synchronise the marker's internal reference to master signal. The control centre then requests the marker to again transmit a packet timed to the marker's internal reference signal and the control centre can then check that the signal is now within tolerance. Failure for the signal to be re-synchronised within tolerance will signal an error to the operator who can then take appropriate action, including scheduling maintenance visit.

A control board 72 under microprocessor control may include functions to count the number of globes left and monitor the status of the marker. The central control centre can then call the marker and down the status through the GSM modem. If the control board detects a critical event such as a tamper or no remaining spare globes, the control board can call the central control centre to report the event.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A system of navigational aids comprising a plurality of navigation lights, each light being connected to a flashing circuit such that the light flashes with a predetermined frequency, the system further including synchronisation means to synchronise the flashing circuit with a synchronisation signal.

2. The system of claim 1, wherein the synchronisation means comprises a telemetry system.

3. A telemetry system for communicating with a plurality of navigation lights, each navigation light being connected to a flashing circuit having timing means to provide a time base, and the flashing circuit being arranged to use the time base to flash the light at predetermined intervals, and each flashing circuit being responsive to the telemetry system to synchronise the respective flashing to a synchronising signal transmitted by the telemetry system, such that the flashing of the plurality of lights can be synchronised to one another by the telemetry system.

4. The system as claimed in claim 2 or 3, wherein the telemetry system synchronises a plurality of navigation lights to flash at the same time.

5. The system as claimed in any one of claims 2 to 4, wherein the telemetry system synchronises a plurality of navigation lights to flash in a predetermined sequence.

6. The system as claimed in any one of claims 2 to 5, wherein the telemetry system is arranged to transmit a broadcast reference signal to multiple navigation lights in a waterway to synchronise a reference clock within each navigation light.

7. The system as claimed in claim 6, wherein the reference signal is periodically re-sent to ensure that the internal reference clock of each navigation light is within acceptable limits.

8. The system as claimed in any one of claims 1 to 7, wherein a reference clock of a GPS system provides a synchronisation signal to synchronise a reference clock of each navigation light.

9. The system as claimed in any one of claims 1 to 8, wherein an internal time reference clock of multiple navigation lights are set one by one against a centrally maintained reference signal.

10. The system as claimed in claim 1 or 2, wherein an internal reference clock of each navigation light is synchronised from a continuous reference broadcast signal transmitted via a point to point communication, the continuous reference broadcast being sampled by each navigation light and the respective internal reference clock set.

11. The system as claimed in any one of claims 1 to 5, wherein synchronisation is achieved by transmitting a synchronised signal from one navigation light to another navigation light,

12. The system as claimed in any one of claims 1 to 5, wherein synchronisation is achieved by one navigation light detecting a flash of a light source of another navigation light and to synchronise a reference clock from the detected flash.

13. The system as claimed in any one of claims 1 to 12, wherein the telemetry system includes a monitoring function, capable of collecting information from each of the navigation lights.

14. The system as claimed in claim 13, wherein each navigation light monitors a status of its internal functions and communicates a status of the respective navigation light, including the collected information, to a remote site.

15. The system as claimed in claim 14, wherein communication of the status is via a wireless communication system.

16. The system as claimed in claim 14, wherein communication of the status is via a wired communication system.

17. The system as claimed in claim 14, 15 or 16, wherein the status is communicated to the central monitoring and control centre which monitors lights located at a plurality of widely separated locations.

18. The system as claimed in claim 13, 14, 15, 16 or 17, wherein the information collected from each navigation light includes an indication of the number of spare light blubs left at each navigation light.

19. The system as claimed in claim 13, 14, 15, 16, 17 or 18, wherein the information collected from each navigation light includes information regarding the expected remaining bulb life.

20. The system as claimed in any one of claims 13 to 19, wherein each navigation light includes a light detector arranged to detect flashings of the navigation light and the information collected from each navigation light includes an indication of correct or incorrect flashing.

21. The system as claimed in any one of claims 13 to 20, wherein each navigation light includes a tamper indicator to detect unauthorised entry to the navigation light, and the information collected includes an indication of occurrence or absence of tampering.

22. The system as claimed in any one of claims 13 to 21, wherein the navigation light includes battery monitoring means for monitoring the condition of the battery and the information collected includes an indication of battery condition.

23. The system as claimed in any one of claims 13 to 22, wherein the navigation light includes a power supply monitoring means to monitor correct function of power sources supplying the navigation light and the information collected includes an indication of power source function.

24. The system as claimed in claim 23 wherein the power source is a solar panel.
